(19) United States
(12) Patent Application Publication
(10) Pub. No.: US 2013/0219386 A1
(43) Pub. Date: Aug. 22, 2013

(54) DYNAMIC ALLOCATION OF COMPUTE RESOURCES

(71) Applicants: Jonathan Eric Geibel, Burbank, CA (US); Jeffrey M. Jordan, Valley Village, CA (US); Scott Lane Burris, Palmdale, CA (US); Kevin Christopher Constantine, Sherman Oaks, CA (US)

(72) Inventors: Jonathan Eric Geibel, Burbank, CA (US); Jeffrey M. Jordan, Valley Village, CA (US); Scott Lane Burris, Palmdale, CA (US); Kevin Christopher Constantine, Sherman Oaks, CA (US)

(73) Assignee: DISNEY ENTERPRISES, INC., Burbank, CA (US)

(21) Appl. No.: 13/401,786

(22) Filed: Feb. 21, 2012

(51) Int. Cl. G06F 9/50; G06F 9/455

(52) U.S. Cl. 718/1; 718/104

(57) ABSTRACT

A resource broker determines availability of a portion of a set of compute resources in real-time. The set of compute resources is assigned as a priority to a master process. Further, the resource broker assigns the portion of the set of compute resources to an auxiliary process if the portion of the set of compute resources is available. In addition, the resource broker determines that the master process is attempting to utilize the portion of the set of compute resources. The resource broker also assigns the portion of the set of compute resources to the master process from the auxiliary process without an interruption that exceeds a predetermined time threshold of processing being performed by the master process.

### BACKGROUND

1. Field

This disclosure generally relates to the field of computer systems. More particularly, the disclosure relates to prioritization of compute resources.

2. General Background

A compute system may involve various compute nodes that attempt to gain access to compute resources. A compute node may be a computing device, a program executed on a computing device, an operating system, a function, or the like. Further, examples of compute resources include a central processing unit (“CPU”), a memory, or the like. A particular compute node may have priority over a set of compute resources, but may not be utilizing all of those compute resources at all times. In addition, that compute node may need the compute resources that it is utilizing to operate without being slowed down or disrupted. As an example, a desktop computer may have a plurality of processors that is not fully being utilized at all times by a user. However, the user may need to access all of those processors at any given time. Current approaches do not adequately prevent disruption of a compute node that has priority over a set of compute resources.

### SUMMARY

In one aspect of the disclosure, a computer program product is provided. The computer program product includes a computer readable medium having a computer readable program stored thereon. The computer readable program when executed on a computer causes the computer to determine, with a resource broker, availability of a portion of a set of compute resources in real-time. The set of compute resources is assigned as a priority to a master process. Further, the computer readable program when executed on the computer causes the computer to assign, with the resource broker, the portion of the set of compute resources to an auxiliary process if the portion of the set of compute resources is available. In addition, the computer readable program when executed on the computer causes the computer to determine, with the resource broker, that the master process is attempting to utilize the portion of the set of compute resources. The computer readable program when executed on the computer also causes the computer to assign, with the resource broker, the portion of the set of compute resources to the master process from the auxiliary process without an interruption that exceeds a predetermined time threshold of processing being performed by the master process.

In another aspect of the disclosure, a process is provided. The process determines, with a resource broker, availability of a portion of a set of compute resources in real-time. The set of compute resources is assigned as a priority to a master process. Further, the process assigns, with the resource broker, the portion of the set of compute resources to an auxiliary process if the portion of the set of compute resources is available. In addition, the process determines, with the resource broker, that the master process is attempting to utilize the portion of the set of compute resources. The process also assigns, with the resource broker, the portion of the set of compute resources to the master process from the auxiliary process without an interruption that exceeds a predetermined time threshold of processing being performed by the master process.

In yet another aspect of the disclosure, a system is provided. The system includes a resource broker that determines availability of a portion of a set of compute resources in real-time, assigns the portion of the set of compute resources to an auxiliary process if the portion of the set of compute resources is available, determines that the master process is attempting to utilize the portion of the set of compute resources, and assigns the portion of the set of compute resources to the master process from the auxiliary process without an interruption that exceeds a predetermined time threshold of processing being performed by the master process. The set of compute resources is assigned as a priority to a master process.

In another aspect of the disclosure, a computer program product is provided. The computer program product includes a computer readable medium having a computer readable program stored thereon. The computer readable program when executed on a computer causes the computer to execute, at a compute node, a master process with a first portion of a set of compute resources. The set of compute resources is assigned as a priority to the master process. Further, the computer readable program when executed on the computer causes the computer to receive an indication, at the compute node from a resource broker, of availability of a second portion of the set of compute resources in real-time. In addition, the computer readable program when executed on the computer causes the computer to execute, at the compute node, an auxiliary process with the second portion of the set of compute resources if the second portion of the set of compute resources is available. The computer readable program when executed on the computer also causes the computer to determine, at the compute node, that the master process is attempting to utilize the second portion of the set of compute resources. Further, the computer readable program when executed on the computer causes the computer to transfer the second portion of the set of compute resources to the master process from the auxiliary process. In addition, the computer readable program when executed on the computer causes the computer to process, at the compute node, the master process with the second portion of the set of compute resources without an interruption that exceeds a predetermined time threshold.

In yet another aspect of the disclosure, a process is provided. The process executes, at a compute node, a master process with a first portion of a set of compute resources. The set of compute resources is assigned as a priority to the master process. Further, the process receives an indication, at the compute node from a resource broker, of availability of a second portion of the set of compute resources in real-time. In addition, the process executes, at the compute node, an auxiliary process with the second portion of the set of compute resources if the second portion of the set of compute resources is available. The process also determines, at the compute node, that the master process is attempting to utilize the second portion of the set of compute resources. Further, the process transfers the second portion of the set of compute resources to the master process from the auxiliary process. In addition, the process processes, at the compute node, the master process with the second portion of the set of compute resources without an interruption that exceeds a predetermined time threshold.

In another aspect of the disclosure, a system is provided. The system includes a processor that executes a master process with a first portion of a set of compute resources, receives an indication of availability of a second portion of the set of compute resources in real-time, executes an auxiliary process with the second portion of the set of compute resources if the second portion of the set of compute resources is available, determines that the master process is attempting to utilize the second portion of the set of compute resources, transfers the second portion of the set of compute resources to the master process from the auxiliary process, and processes the master process with the second portion of the set of compute resources without an interruption. The set of compute resources is assigned as a priority to the master process that exceeds a predetermined time threshold.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a system that may be utilized to perform dynamic allocation of compute resources.

FIG. 2 illustrates an example of a compute node.

FIGS. 3A-3C illustrate a dynamic resource allocation configuration 300.

FIG. 3A illustrates a client A that has priority over the set of compute resources.

FIG. 3B illustrates a client B that requests compute resources from the set of compute resources over which the client A has priority.

FIG. 3C illustrates a transfer of compute resource back from the client B to the client A.

FIG. 4 illustrates a process that is utilized to provide dynamic resource allocation by the resource broker.

FIG. 5 illustrates a process that is utilized to provide dynamic resource allocation at the compute node.

FIG. 6 illustrates a dynamic compute resource allocation system that utilizes a plurality of virtual machines (“VMs”) to perform auxiliary work.

### DETAILED DESCRIPTION

A resource broker may be utilized to provide dynamic allocation of compute resources. The resource broker may be a process generated by an operating system, a set of code, a function, a module, or the like that is executed alongside of a master process. The master process may be a process generated by an operating system, a set of code, a function, a module, or the like that has priority over a set of compute resources residing on a compute node. The resource broker analyzes in real-time (or substantially real-time) what compute resources are available to be utilized by an auxiliary process. As used herein, real-time may include very small time delays caused by electrical signals sent through a circuit or a system. An auxiliary process may be a process generated by an operating system, a set of code, a function, a module, or the like that would like to utilize at least a portion of the compute resources residing on the compute node over which the master process has priority. The resource broker takes action to transfer compute resources that are not currently being utilized by the master process to the auxiliary process. Further, the resource broker takes further action to take back any of those transferred compute resources and transfer them back to the master process without an interruption to the master process that exceeds a predetermined time threshold. As an example, the predetermined time threshold for an interruption that is unnoticed by a user may be in the approximate range of zero milliseconds to six seconds. As another example, the predetermined time threshold for an interruption that is noticed by the user may be in the approximate range of zero milliseconds to ten minutes. Any of the ranges provided herein are provided merely as examples. The time threshold may be utilized with a variety of other ranges. The resource broker keeps as much of the set compute resources as possible busy at any given time, but avoids or minimizes disruption or delay to a master process that has priority over the set of resources. As a result, any available compute resources are utilized whenever ancillary work is available to run without affecting the performance of the master process. Accordingly, dynamic allocation of compute resources may be achieved via the resource broker tracking the uninterruptable work load in real-time, allocating excess compute resources to an auxiliary process, and transferring any of those excess compute resources back to the master process if the master function requires access to those excess compute resources.

In one aspect, a VM may be instantiated to accomplish auxiliary work when compute resources are made available. A VM is a software implementation of a computing device that executes programs like a physical computing device, but in a virtual manner. Further, in one aspect, the VM may be transient such that it is generated to accomplish auxiliary work and discarded after the auxiliary work has been completed.

The resource broker, compute nodes, and other elements described herein may be used to generate or modify an image or a sequence of images for an animation. For example, the elements described herein may be used for modeling objects (shaping geometry), layout, rigging, look development, stereoscopic creation and manipulation (depth perception), animation (movement, computational dynamics), lighting, rendering, and/or color correction.

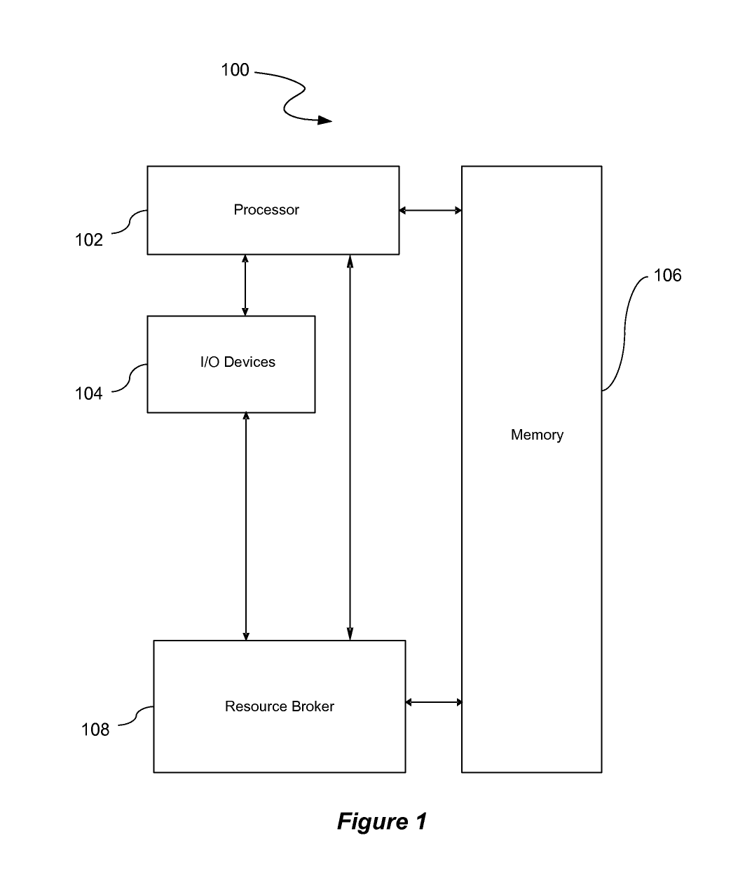

FIG. 1 illustrates a system 100 that may be utilized to perform dynamic allocation of compute resources. In one aspect, the system 100 is implemented utilizing a general purpose computer or any other hardware equivalents. Thus, the system 100 comprises a processor 102, a memory 106, e.g., random access memory (“RAM”) and/or read only memory (ROM), a resource broker 108, and various input/output devices 104, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). In one aspect, the resource broker 108 is implemented as a module. Various other configurations for the resource broker 108 may be utilized.

It should be understood that the resource broker 108 may be implemented as one or more physical devices that are coupled to the processor 102. For example, the resource broker 108 may include a plurality of modules. Alternatively, the resource broker 108 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor 102 in the memory 106 of the system 100. As such, the resource broker 108 (including associated data structures) of the present disclosure may be stored on a computer readable medium, e.g., RAM memory, magnetic or optical drive or diskette and the like.

The system 100 may be utilized to implement any of the configurations herein. In another aspect, the processor 102 is the resource broker 108. Accordingly, in such an aspect, a resource broker 108 that is separate from the processor 102 is unnecessary. FIG. 1 provides an example of an implementation of a dynamic compute resource allocation. However, the dynamic resource allocation system is not limited to any particular model and may be implemented with similar and/or different components from this example.

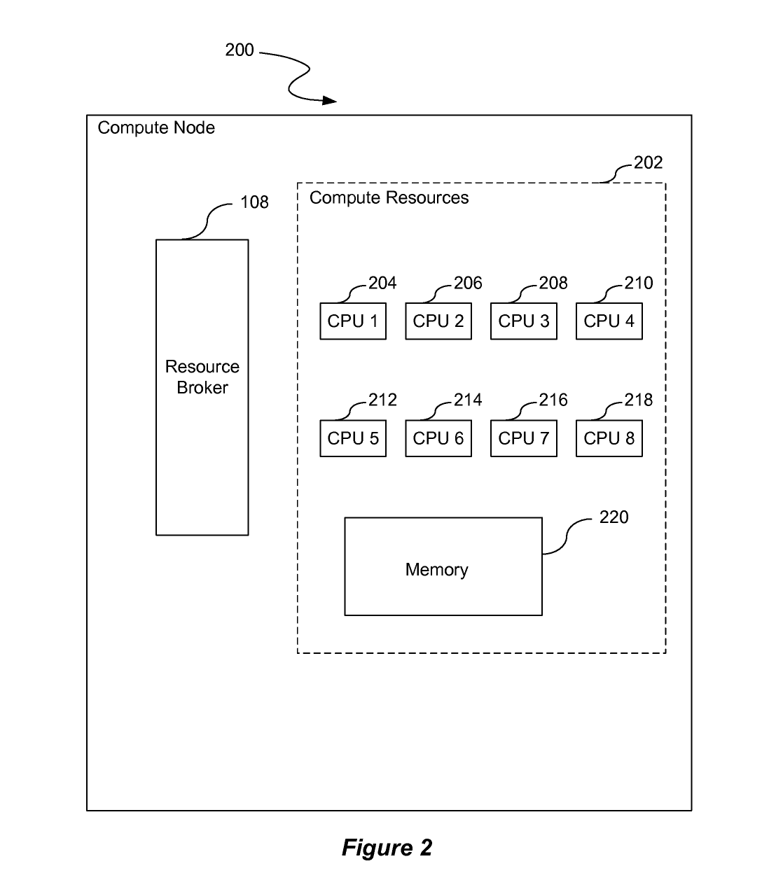

The resource broker 108 of the system 100 illustrated in FIG. 1 may perform dynamic resource allocation for a compute node. FIG. 2 illustrates an example of a compute node 200. The compute node 200 may have a set of compute resources 202. For example, the set of compute resources 202 may include a plurality of CPUs such as a first CPU 204, a second CPU 206, a third CPU 208, a fourth CPU 210, a fifth CPU 212, a sixth CPU 214, a seventh CPU 216, and an eighth CPU 218. Further, the set of compute resources 202 may have a memory 220. The illustrated set of compute resources 202 is provided only as an example. The compute node 200 may have various other types and/or quantities of compute resources.

In one aspect, the resource broker 108 is implemented on the compute node 200. However, the resource broker 108 may be implemented on an external compute node that interacts with the compute node 200.

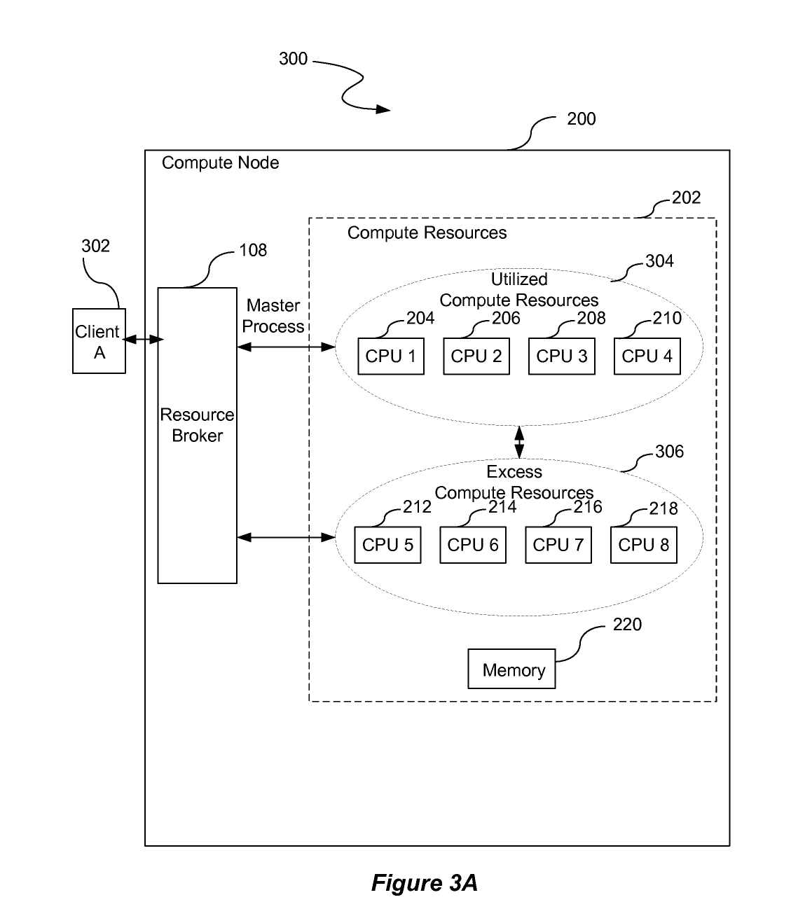

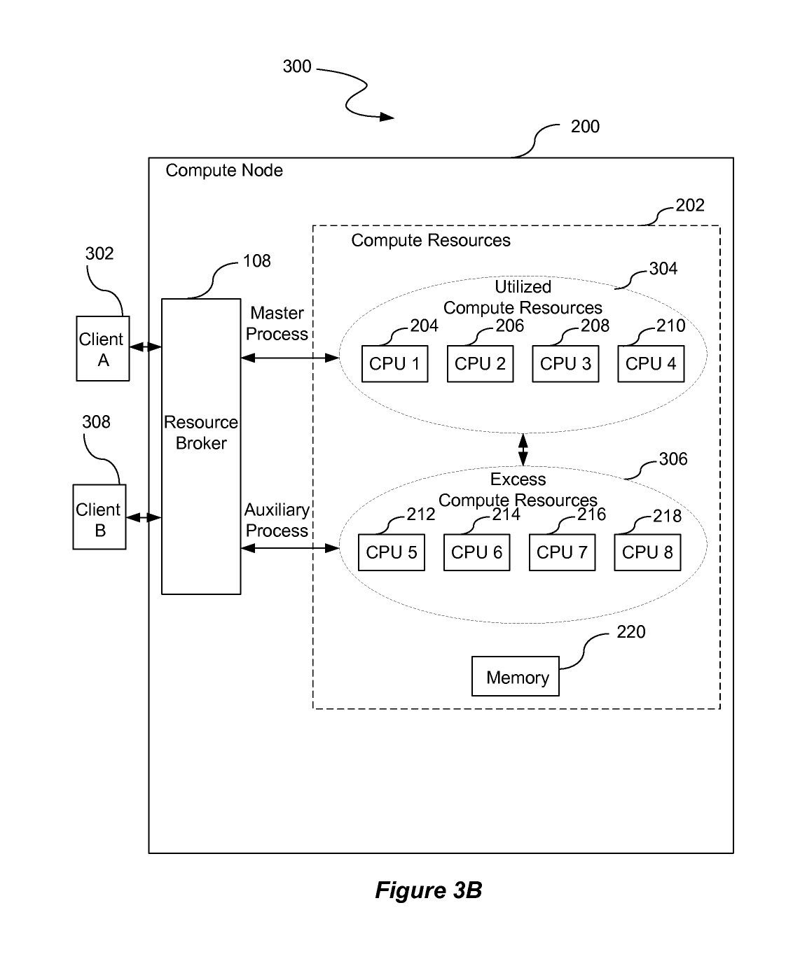

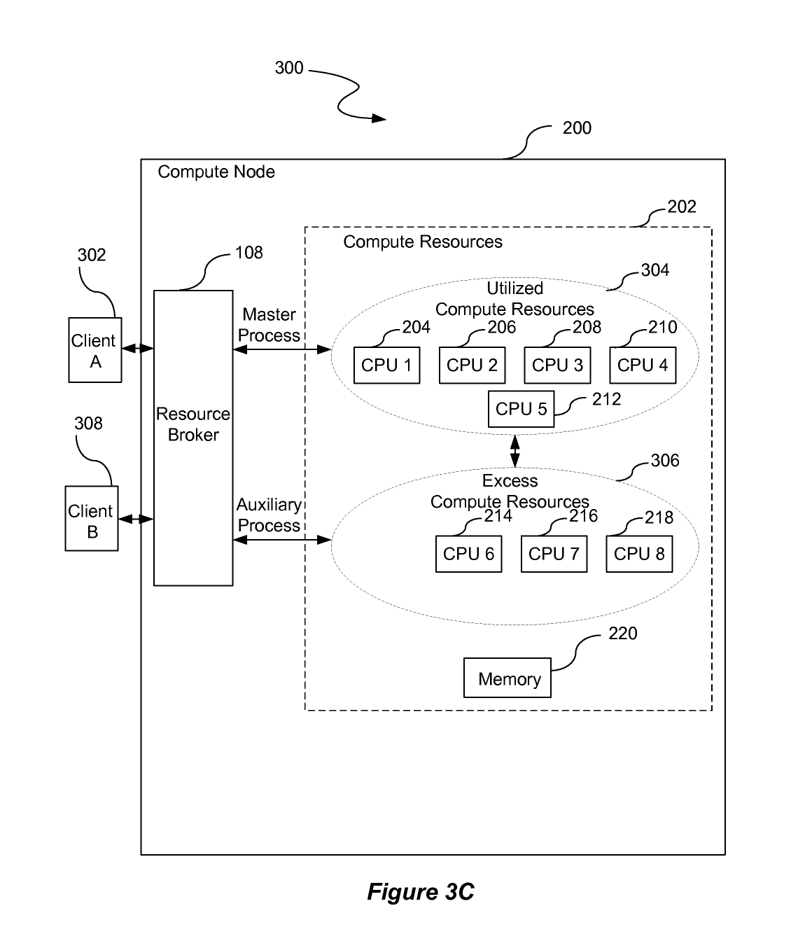

FIGS. 3A-3C illustrates a dynamic resource allocation configuration 300. As an example, FIG. 3A illustrates a client A 302 that has priority over the set of compute resources 202. In one aspect, a master process utilizes some or all of the set of compute resources 202 at any given time to perform tasks for the client A 302. In particular, the set of compute resources 202 has a set of utilized compute resources 304 and a set of excess compute resources 306. The set of utilized compute resources 304 includes the compute resources that are currently being utilized by the client A 302. As an example, the set of utilized compute resources 304 includes the first CPU 204, the second CPU 206, the third CPU 208, and the fourth CPU 210. Further, the set of excess compute resources 306 includes the compute resources that are not currently being utilized by the client A 302. As an example, the set of excess compute resources 306 may include the fifth CPU 212, the sixth CPU 214, the seventh CPU 216, and the eighth CPU 218. At any given time, the master process may need a compute resource from the set of excess compute resources 306.

The resource broker 108 monitors the prioritized workload by communicating with the set of utilized compute resources 304. Further, the resource broker 108 monitors the availability of available compute resources for other clients in the set of excess compute resources 306.

Further, as an example, FIG. 3B illustrates a client B 308 that requests compute resources from the set of compute resources 202 over which the client A 302 has priority. In one aspect, the resource broker 108 may make a real-time determination as to which, if any, excess compute resources are available. The resource broker 108 may then transfer (or assign) some or all of the excess compute resources in the set of excess compute resources 306 from the master process to an auxiliary process for utilization by the client B 308. However, the transferred compute resources are interruptible, whereas resources being utilized by the master process are uninterruptable. Since the transferred compute resources are interruptible, the resource broker 108 may interrupt any work being performed by the client B 308 with the transferred compute resources and transfer such compute resources back to the master process without any interruption that exceeds a predetermined time threshold of the master process. As an example, the resource broker 108 may determine in real-time that the fifth CPU 212, the sixth CPU 214, the seventh CPU 216, and the eighth CPU 218 are currently available as they are part of the set of excess compute resources 306. Accordingly, the resource broker 108 may transfer these compute resources to an auxiliary process for the client B 306. As an example, the resource broker 108 may instruct the compute node 200 to dispatch a task for each of the CPUs that is utilized by the auxiliary process.

In addition, as an example, FIG. 3C illustrates a transfer of compute resource back from the client B 308 to the client A 302. For instance, the resource broker 108 may determine in real-time that the master process for the client A 302 needs the fifth CPU 212. Accordingly, the resource broker 108 may preempt utilization by the auxiliary process of the client B 308 of the fifth CPU 212 and transfer the fifth CPU 212 back to the set of utilized compute resources 304 so that the master process of the client A 302 may proceed without interruption that exceeds a predetermined time threshold.

In one aspect, the resource broker 108 may report to an interactive client or interactive user if an elongated moment of memory contention is detected during the transfer of a compute resource back to the master process. For example, the user at the client A 302 may receive a message such as a text message, pop up message, or the like that a small interruption may occur.

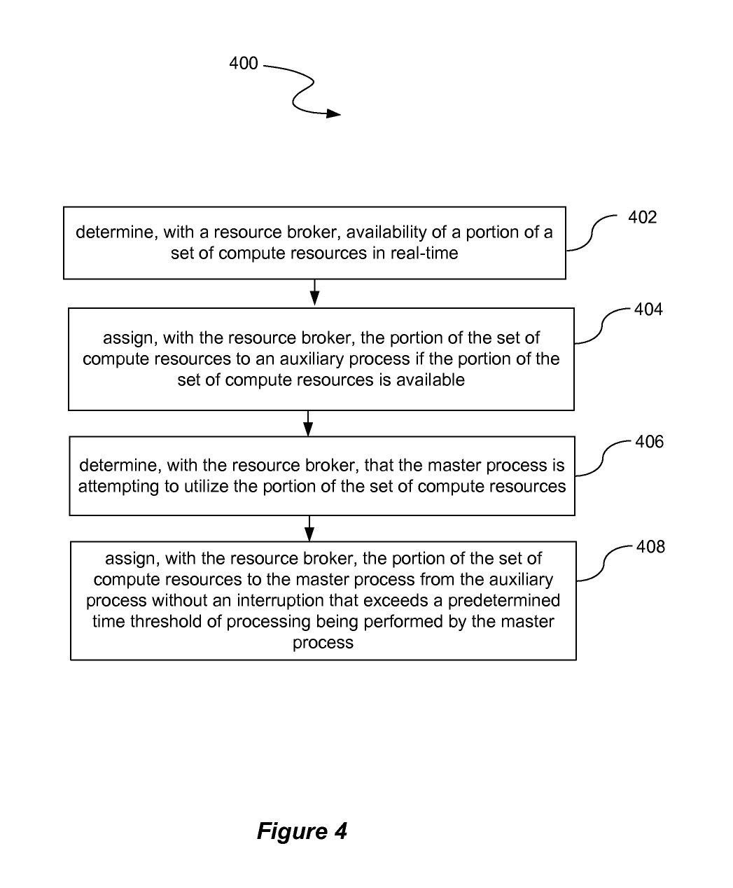

FIG. 4 illustrates a process 400 that is utilized to provide dynamic resource allocation by the resource broker 108. At a process block 402, the process 400 determines, with the resource broker 108, availability of a portion of a set of compute resources 202 in real-time. The set of compute resources 200 is assigned as a priority to a master process. Further, at a process block 404, the process 400 assigns, with the resource broker 108, the portion of the set of compute resources 202 to an auxiliary process if the portion of the set of compute resources 202 is available. In addition, at a process block 406, the process 400 determines, with the resource broker 108, that the master process is attempting to utilize the portion of the set of compute resources 202. At a process block 408, the process 400 also assigns, with the resource broker 108, the portion of the set of compute resources 202 to the master process from the auxiliary process without an interruption that exceeds a predetermined time threshold of processing being performed by the master process.

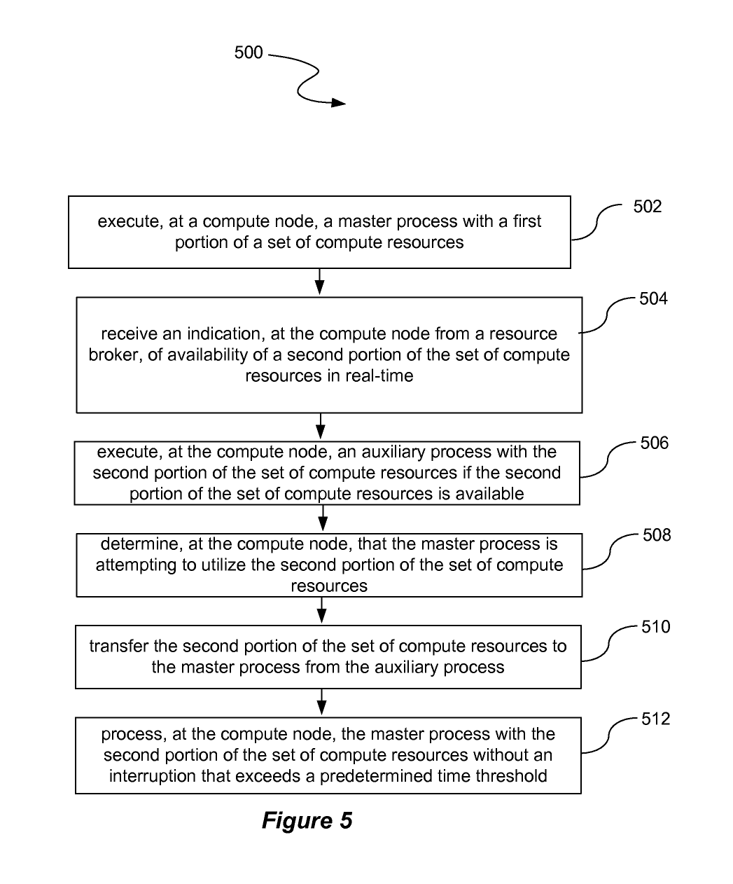

FIG. 5 illustrates a process 500 that is utilized to provide dynamic resource allocation at the compute node 200. At a process block 502, the process 500 executes, at the compute node 200, a master process with a first portion of a set of compute resources 202. The set of compute resources is assigned as a priority to the master process. Further, at a process block 504, the process 500 receives an indication, at the compute node 200 from the resource broker 108, of availability of a second portion of the set of compute resources 202 in real-time. In addition, at a process block 506, the process 500 executes, at the compute node 200, an auxiliary process with the second portion of the set of compute resources 202 if the second portion of the set of compute resources 202 is available. At a process block 508, the process 500 also determines, at the compute node 200, that the master process is attempting to utilize the second portion of the set of compute resources 202. Further, at a process block 510, the process 500 transfers the second portion of the set of compute resources 202 to the master process from the auxiliary process. In addition, at a process block 512, the process 500 processes, at the compute node 200, the master process with the second portion of the set of compute resources without an interruption that exceeds a predetermined time threshold.

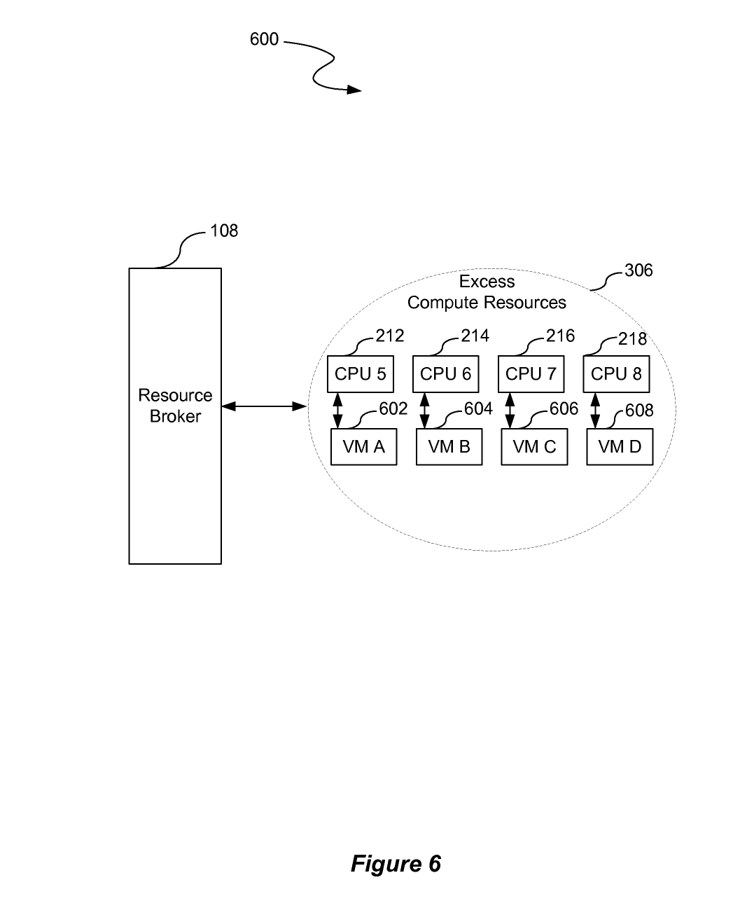

With any of the configurations provided for herein, the resource broker 108 may utilize a variety of hardware devices, software implementations, or the like to execute operations to dynamically allocate compute resources to accomplish auxiliary work whenever compute resources are available. For example, the resource broker 108 may instantiate transient VMs to perform such dynamic allocation to accomplish the auxiliary work. FIG. 6 illustrates a dynamic compute resource allocation system 600 that utilizes a plurality of VMs to perform auxiliary work. For example, a VM A 602 may be utilized to perform work with the fifth CPU 212, a VM B 604 may be utilized to perform work with a sixth CPU 214, a VM C 606 may be utilized to perform work with a seventh CPU 216, and a VM D 608 may be utilized to perform work with an eight CPU 218. If the resource broker 108 wishes to transfer a compute resource back to a master process from an auxiliary process, the resource broker 108 may pause the VM. For example, if the auxiliary process of the client B 304 is utilizing the fifth CPU 212, the resource broker 108 may pause the VM A 602 to transfer the fifth CPU 212 back to the master process of the client A 302. By pausing the VM, the resource broker 108 may transfer a compute resource back to the master process immediately.

As another example, the resource broker 108 may discard a VM. As a result, CPUs and the memory may be transferred back to the master process immediately.

As yet another example, the VM may be stored locally on a storage device in local communication with a portion of the set of compute resources 202 so that the portion of the set of compute resources 202 is transferred to the master process. As a result, the master process may access the CPUs immediately and memory after a short delay. Active memory pages are sent to a local disk. Alternatively, the VM may be stored externally on a storage device in external communication with the portion of the set of compute resources 202 so that the portion of the set of compute resources 202 is transferred to the master process. Active memory pages are sent over a network to a central compute resource.

As another example, the resource broker 108 may migrate the VM from a first compute node to a second compute node. As a result, the VM may continue to run without disruption.

In one aspect, the VMs are transient VMs that may withstand interruptions in service. Further, in another aspect, the VMs are managed by an external entity other than the resource broker 108.

Although FIG. 6 illustrates a VM for each CPU, other configurations may also be utilized. For example, a VM may be utilized for multiple CPUs.

In one aspect, the operating system running the uninterruptable compute workload, e.g., the set of utilized compute resources 304, may be running inside of a VM itself. Alternatively, the operating system running the uninterruptable compute workload may run directly on physical hardware.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool.

A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a computer readable storage device having a computer readable program stored thereon, wherein the computer readable program when executed on a computer causes the computer to:
determine, with a resource broker, availability of a portion of a set of compute resources in real-time, the set of compute resources being assigned as a priority to a master process;
assign, with the resource broker, the portion of the set of compute resources to an auxiliary process if the portion of the set of compute resources is available;
determine, with the resource broker, that the master process is attempting to utilize the portion of the set of compute resources; and
assign, with the resource broker, the portion of the set of compute resources to the master process from the auxiliary process without an interruption that exceeds a predetermined time threshold of processing being performed by the master process.

2. The computer program product of claim 1, wherein the computer is further caused to instantiate a virtual machine to perform processing of the portion of the set of compute resources by the auxiliary process.

3. The computer program product of claim 2, wherein the computer is further caused to instruct, with the resource broker, the virtual machine to pause so that the portion of the set of compute resources is transferred to the master process.

4. The computer program product of claim 2, wherein the computer is further caused to discard, with the resource broker, the virtual machine so that the portion of the set of compute resources is transferred to the master process.

5. The computer program product of claim 2, wherein the computer is further caused to store the virtual machine locally on a storage device in local communication with the portion of the set of compute resources so that the portion of the set of compute resources is transferred to the master process.

6. The computer program product of claim 2, wherein the computer is further caused to store the virtual machine externally on a storage device in external communication with the portion of the set of compute resources so that the portion of the set of compute resources is transferred to the master process.

7. The computer program product of claim 2, wherein the computer is further caused to migrate, with the resource broker, the virtual machine from a first compute node to a second compute node so that the portion of the set of compute resources is transferred to the master process.

8. A method comprising:
determining, with a resource broker, availability of a portion of a set of compute resources in real-time, the set of compute resources being assigned as a priority to a master process;
assigning, with the resource broker, the portion of the set of compute resources to an auxiliary process if the portion of the set of compute resources is available;
determining, with the resource broker, that the master process is attempting to utilize the portion of the set of compute resources; and
assigning, with the resource broker, the portion of the set of compute resources to the master process from the auxiliary process without an interruption that exceeds a predetermined time threshold of processing being performed by the master process.

9. The method of claim 8, further comprising instantiating a virtual machine to perform processing of the portion of the set of compute resources by the auxiliary process.

10. The method of claim 8, further comprising instructing, with the resource broker, the virtual machine to pause so that the portion of the set of compute resources is transferred to the master process.

11. The method of claim 8, further comprising discarding, with the resource broker, the virtual machine so that the portion of the set of compute resources is transferred to the master process.

12. The method of claim 8, further comprising storing the virtual machine locally on a storage device in local communication with the portion of the set of compute resources so that the portion of the set of compute resources is transferred to the master process.

13. The method of claim 8, further comprising storing the virtual machine externally on a storage device in external communication with the portion of the set of compute resources so that the portion of the set of compute resources is transferred to the master process.

14. The method of claim 8, with the resource broker, the virtual machine from a first compute node to a second compute node so that the portion of the set of compute resources is transferred to the master process.

15. A system comprising:
a resource broker that determines availability of a portion of a set of compute resources in real-time, assigns the portion of the set of compute resources to an auxiliary process if the portion of the set of compute resources is available, determines that the master process is attempting to utilize the portion of the set of compute resources, and assigns the portion of the set of compute resources to the master process from the auxiliary process without an interruption that exceeds a predetermined time threshold of processing being performed by the master process, the set of compute resources being assigned as a priority to a master process.

16. A computer program product comprising a computer readable storage device having a computer readable program stored thereon, wherein the computer readable program when executed on a computer causes the computer to:
execute, at a compute node, a master process with a first portion of a set of compute resources, the set of compute resources being assigned as a priority to the master process;
receive an indication, at the compute node from a resource broker, of availability of a second portion of the set of compute resources in real-time;
execute, at the compute node, an auxiliary process with the second portion of the set of compute resources if the second portion of the set of compute resources is available;
determine, at the compute node, that the master process is attempting to utilize the second portion of the set of compute resources;
transfer the second portion of the set of compute resources to the master process from the auxiliary process; and
process, at the compute node, the master process with the second portion of the set of compute resources without an interruption that exceeds a predetermined time threshold.

17. The computer program product of claim 16, wherein the computer is further caused to instantiate a virtual machine at the compute node to perform processing of the portion of the set of compute resources by the auxiliary process.

18. The computer program product of claim 17, wherein the computer is further caused to instruct the virtual machine to pause so that the second portion of the set of compute resources is transferred to the master process.

19. The computer program product of claim 17, wherein the computer is further caused to discard the virtual machine so that the second portion of the set of compute resources is transferred to the master process.

20. The computer program product of claim 17, wherein the computer is further caused to store the virtual machine locally at the compute node in local communication with the second portion of the set of compute resources so that the second portion of the set of compute resources is transferred to the master process.

21. The computer program product of claim 17, wherein the computer is further caused to store the virtual machine externally on a storage device ad an additional compute node in external communication with the portion of the second set of compute resources so that the portion of the second set of compute resources is transferred to the master process.

22. The computer program product of claim 17, wherein the computer is further caused to migrate the virtual machine from the compute node to an additional compute node so that the second portion of the set of compute resources is transferred to the master process.

23. A method comprising:
executing, at a compute node, a master process with a first portion of a set of compute resources, the set of compute resources being assigned as a priority to the master process;
receiving an indication, at the compute node from a resource broker, of availability of a second portion of the set of compute resources in real-time;
executing, at the compute node, an auxiliary process with the second portion of the set of compute resources if the second portion of the set of compute resources is available;
determining, at the compute node, that the master process is attempting to utilize the second portion of the set of compute resources;
transferring the second portion of the set of compute resources to the master process from the auxiliary process; and
processing, at the compute node, the master process with the second portion of the set of compute resources without an interruption that exceeds a predetermined time threshold.

24. The method of claim 23, further comprising instantiating a virtual machine at the compute node to perform processing of the portion of the set of compute resources by the auxiliary process.

25. The method of claim 23, wherein the compute node is a server.

26. The method of claim 23, wherein the compute node is a computing device.

27. The method of claim 23, wherein the set of compute resources includes a processor.

28. The method of claim 23, wherein the set of compute resources includes a memory.

29. A system comprising:
a processor that executes a master process with a first portion of a set of compute resources, receives an indication of availability of a second portion of the set of compute resources in real-time, executes an auxiliary process with the second portion of the set of compute resources if the second portion of the set of compute resources is available, determines that the master process is attempting to utilize the second portion of the set of compute resources, transfers the second portion of the set of compute resources to the master process from the auxiliary process, and processes the master process with the second portion of the set of compute resources without an interruption that exceeds a predetermined time threshold, the set of compute resources being assigned as a priority to the master process.
